(19) United States
(12) Patent Application Publication
(10) Pub. No.: US 2012/0305457 A1
(43) Pub. Date: Dec. 6, 2012

(54) WATER FILTER AND ALERT ASSEMBLY FOR BATHROOM USE

(76) Inventor: Duan Yao, Homei (TW)

(21) Appl. No.: 13/151,077

(22) Filed: Jun. 1, 2011

(51) Int. Cl. B01D 35/14; B01D 35/02; C02F 1/00

(52) U.S. Cl. 210/85

(57) ABSTRACT

A water filter and alert assembly for bathroom use includes a housing, at least one filter element, an alert device, and a cap. The housing has an externally threaded end, an internally threaded end, and a water passageway. The at least one filter element is disposed in the water passageway. The alert device includes a temperature sensing element and a temperature indicating element, wherein the temperature sensing element is provided in the water passageway to sense water temperature, and the temperature indicating element is configured to show water temperature and alert messages. The cap has an externally threaded end and an internally threaded end. The internally threaded end of the cap is connected with the externally threaded end of the housing so as to guide outgoing water and retain the at least one filter element.

### BACKGROUND OF THE INVENTION

1. Technical Field

The present invention relates to a water filter and alert assembly which is designed for bathroom use and features both sterilization and safety alert functions.

2. Description of Related Art

Water for household use comes mainly from the waterworks. In order to ensure that tap water meets sanitary requirements and conforms to the safety standards of drinking water, chlorination is required in the water treatment procedures of public water supply facilities.

Chlorinated tap water, though safely potable after boiling, could be hazardous when directly used in baths and showers, not only because an excessive amount of chlorine is harmful to the human body, but also because chlorinated tap water may still contain bacteria and impurities. Therefore, women in their menstrual period and young children are subject to bacterial infection when taking a bath or shower with chlorinated tap water.

In addition, water supply equipment for use in the bathroom typically does not come with a temperature controlling structure. Water is directly sprayed out of a shower head when the faucet is turned on. Hence, in order take a warm water shower, it is common practice for the user to feel the temperature of the water with his or her hand until the water temperature gradually rises to the desired level. As the water temperature may vary with the closeness of the valve in the faucet, the faucet must be controlled carefully to produce the desired water temperature, which process, however, is very inconvenient. Moreover, it is dangerous to bathe or shower a young child without knowing the water temperature every step of the way.

### BRIEF SUMMARY OF THE INVENTION

It is an object of the present invention to provide a water filter and alert assembly for use in the bathroom, wherein the assembly not only is capable of sterilization, but also has an alert device for sensing and indicating water temperature so as to provide safety alert.

To achieve the above and other objects, the present invention provides a water filter and alert assembly for bathroom use, wherein the assembly includes a housing, at least one filter element, an alert device, and a cap. The housing has an externally threaded end, an internally threaded end, and a water passageway. The at least one filter element is provided in the water passageway. The alert device is installed on the housing and includes a temperature sensing element and a temperature indicating element. The temperature sensing element lies in the water passageway so as to sense the temperature of water passing through the water passageway, and the temperature indicating element shows different alert messages depending on the water temperature sensed. The cap has an externally threaded end and an internally threaded end. The internally threaded end of the cap is connected with the externally threaded end of the housing so as to guide outgoing water and retain the at least one filter element.

The water filter and alert assembly of the present invention further includes a safety valve provided in the water passageway. When the temperature of water passing through the water passageway reaches a predetermined high temperature value, the valve stem of the safety valve blocks the water passageway and thereby stops the water from flowing out.

Hence, according to the present invention, chlorine as well as impurities and bacteria in tap water can be filtered out with the at least one filter element while the alert device monitors the temperature of the water being used, wherein the water temperature is sensed by the temperature sensing element and instantly shown via the temperature indicating element and a display panel. Thus, sterilization of tap water and safety alert regarding the use of tap water are simultaneously achieved.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is a schematic drawing of a water filter and alert assembly according to a first embodiment of the present invention;

FIG. 2 is an assembled sectional view of the water filter and alert assembly depicted in FIG. 1;

FIG. 3 is a schematic drawing of a water filter and alert assembly according to a second embodiment of the present invention;

FIG. 4 is an assembled sectional view of the water filter and alert assembly depicted in FIG. 3;

FIG. 5 is an assembled sectional view of a water filter and alert assembly according to a third embodiment of the present invention;

FIG. 6 is an assembled sectional view of a water filter and alert assembly according to a fourth embodiment of the present invention;

FIG. 7 is a side view showing the water filter and alert assembly depicted in FIG. 6 connected to a faucet body;

FIG. 8 is a partial sectional view showing the valve stem of a safety valve blocking water flow;

FIG. 9 is an exploded perspective view of a water filter and alert assembly according to a fifth embodiment of the present invention; and

FIG. 10 is an assembled, partially sectional view of the water filter and alert assembly depicted in FIG. 9.

### DETAILED DESCRIPTION OF THE INVENTION

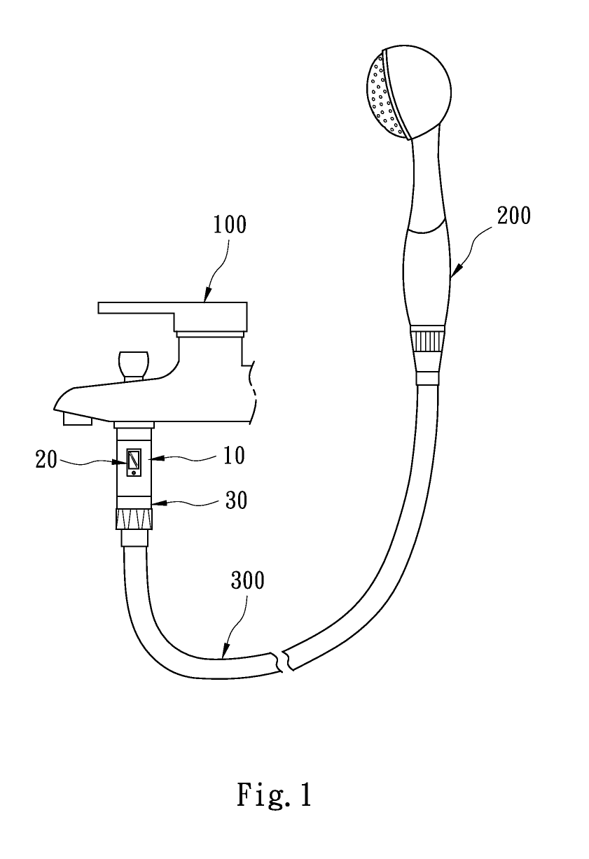

Referring to FIG. 1, a water filter and alert assembly according to a first embodiment of the present invention is connected between a faucet body 100 and a shower head body 200. Also connected between the faucet body 100 and the shower head body 200 is a flexible hose 300. The water filter and alert assembly includes a housing 10, an alert device 20, and a cap 30.

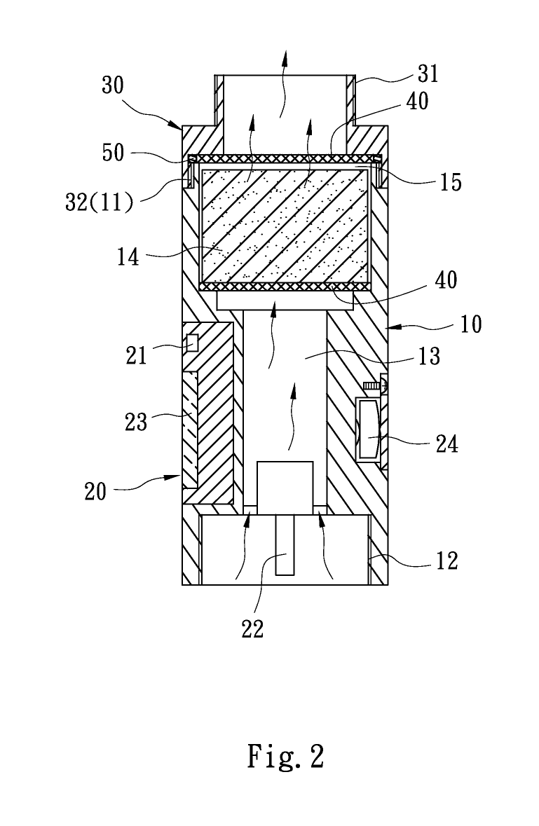

As shown in FIG. 2, the housing 10 has an externally threaded end 11, an internally threaded end 12, and a water passageway 13, wherein the internally threaded end 12 is connected with the faucet body 100. The housing 10 houses at least one filter element 14, and the at least one filter element 14 can include one of a filter sponge, a photocatalyst, activated carbon, a perfume essence, porphyritic andesite, and zeolite. The filter element 14 shown in FIG. 2 is a columnar filter sponge. The housing 10 further has an inner chamber 15 for receiving the filter element 14.

The alert device 20 includes a temperature indicating element 21, a temperature sensing element 22, a display panel 23, and a battery 24. The battery 24 is a mercury battery and serves as the power source of the alert device 20. The temperature sensing element 22 is located in the water passageway 13 and is configured to sense water temperature. The temperature indicating element 21 can show different alert messages according to the water temperature sensed by the temperature sensing element 22. The temperature indicating element 21 can be a light-emitting element which emits green light when the water temperature stays below a predetermined temperature (e.g., 38° C.), and red light when the water temperature is higher than the predetermined temperature, thereby alerting the user.

The cap 30 has an externally threaded end 31 and an internally threaded end 32, wherein the externally threaded end 31 is connected with the hose 300. The internally threaded end 32 of the cap 30 is connected with the externally threaded end 11 of the housing 10 so as to guide outgoing water and keep the filter element 14 in place.

The water filter and alert assembly further includes a plurality of water permeable elements 40 and a sealing ring 50. In this embodiment, the sealing ring 50 and one of the water permeable elements 40 are placed on a central step portion of the cap 30, and the other water permeable element 40 is located on the bottom wall of the inner chamber 15. The water permeable elements 40 are intended to retain the filter element 14 while allowing passage of water.

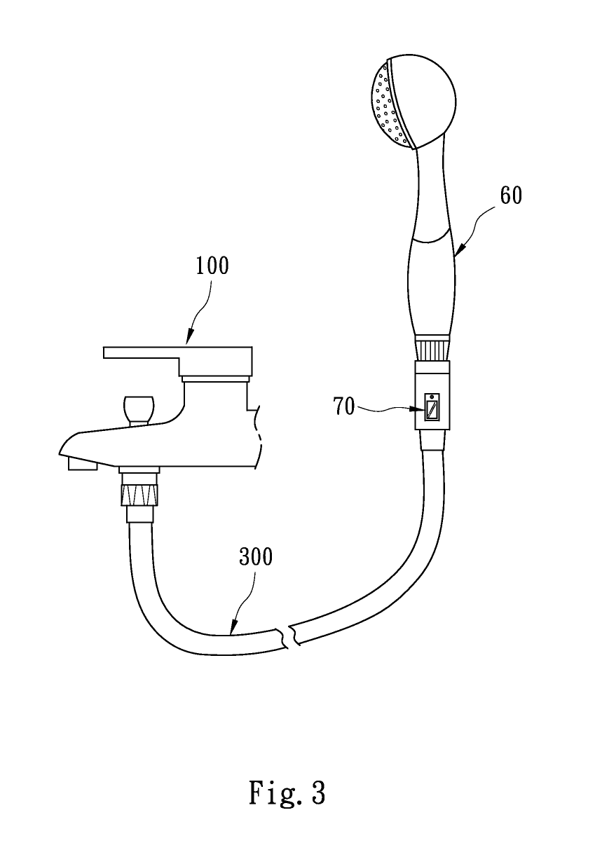

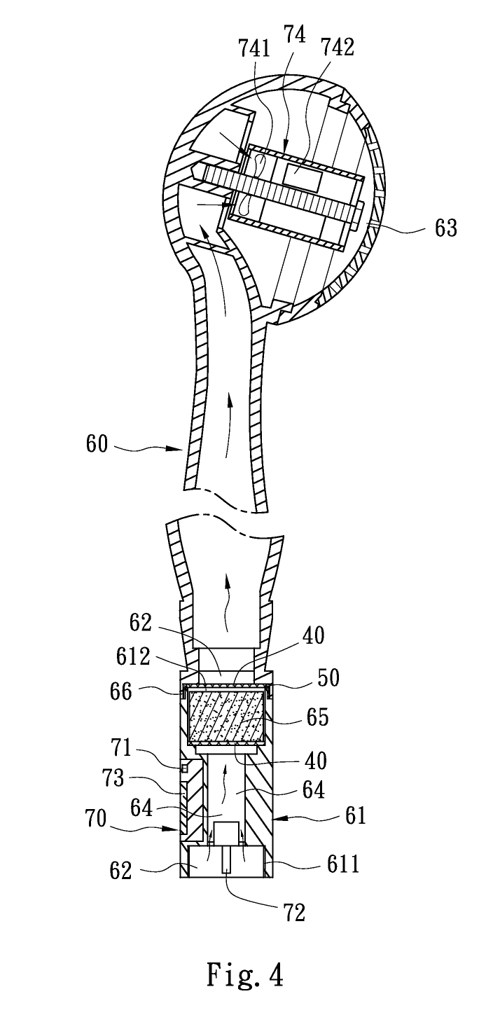

A second embodiment of the present invention is shown in FIGS. 3 and 4, wherein the water filter and alert assembly includes a shower head body 60 and an alert device 70.

The shower head body 60 has a water inlet end 62, a water outlet end 63, and a water passageway 64. The shower head body 60 also includes a tubular element 61 and a plurality of filter elements 65. The tubular element 61 is fastened to an internally threaded end 66 of the shower head body 60 and has an internally threaded end 611 for connection with the hose 300.

In this embodiment, the water filter and alert assembly further includes a plurality of water permeable elements 40 and a sealing ring 50. The sealing ring 50 and one of the water permeable elements 40 are arranged on a central step portion of the shower head body 60, and the other water permeable element 40 is placed on the bottom wall of an inner chamber 612 of the tubular element 61.

The alert device 70, which is provided inside the tubular element 61 of the shower head body 60, includes a temperature indicating element 71, a temperature sensing element 72, and a display panel 73. The alert device 70 also includes a power generation unit 74 located at the water outlet end 63 of the shower head body 60 and including vanes 741 and a controller 742. When water is sprayed from the water outlet end 63, the vanes 741 are driven to rotate by the water flow, and the controller 742 converts the kinetic energy of the vanes 741 into electrical energy, which is supplied to the temperature indicating element 71, the temperature sensing element 72, and the display panel 73 of the alert device 70 to keep the alert device 70 in normal operation. Besides, the controller 742 has a power storage function and can save the electrical energy for later use.

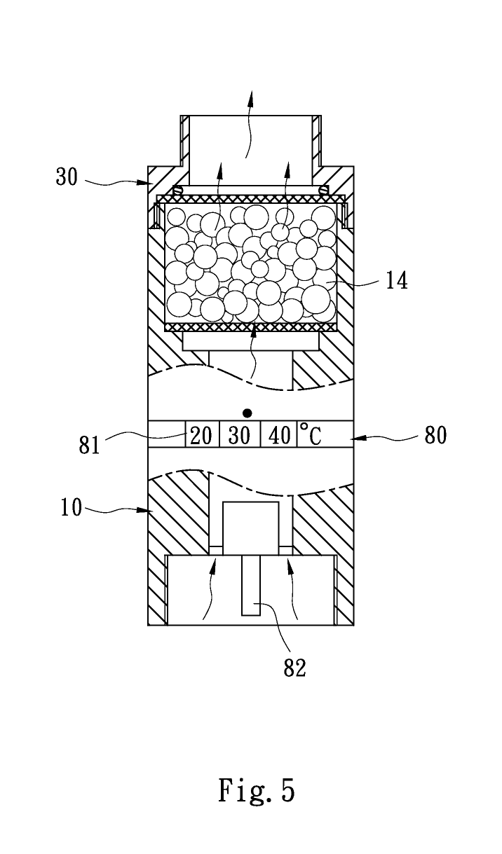

Referring to FIG. 1, a water filter and alert assembly according to a third embodiment of the present invention is connected between the faucet body 100 and the hose 300 or between the shower head body 200 and the hose 300. As shown in FIG. 5, the water filter and alert assembly in this embodiment includes a housing 10, an alert device 80, and a cap 30.

The third embodiment is different from the first embodiment in that the alert device 80 includes a temperature indicating element 81 and a temperature sensing element 82. Furthermore, the filter element 14 in the third embodiment is a granular filter material. The other components and the intended effects of the third embodiment are the same as the first embodiment and therefore are not repeated herein.

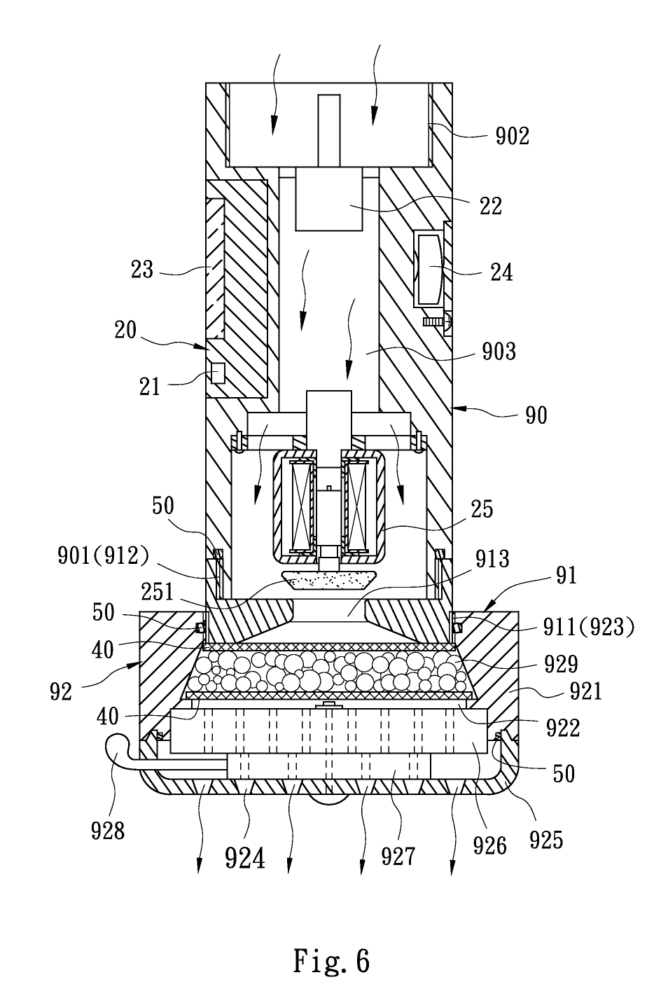

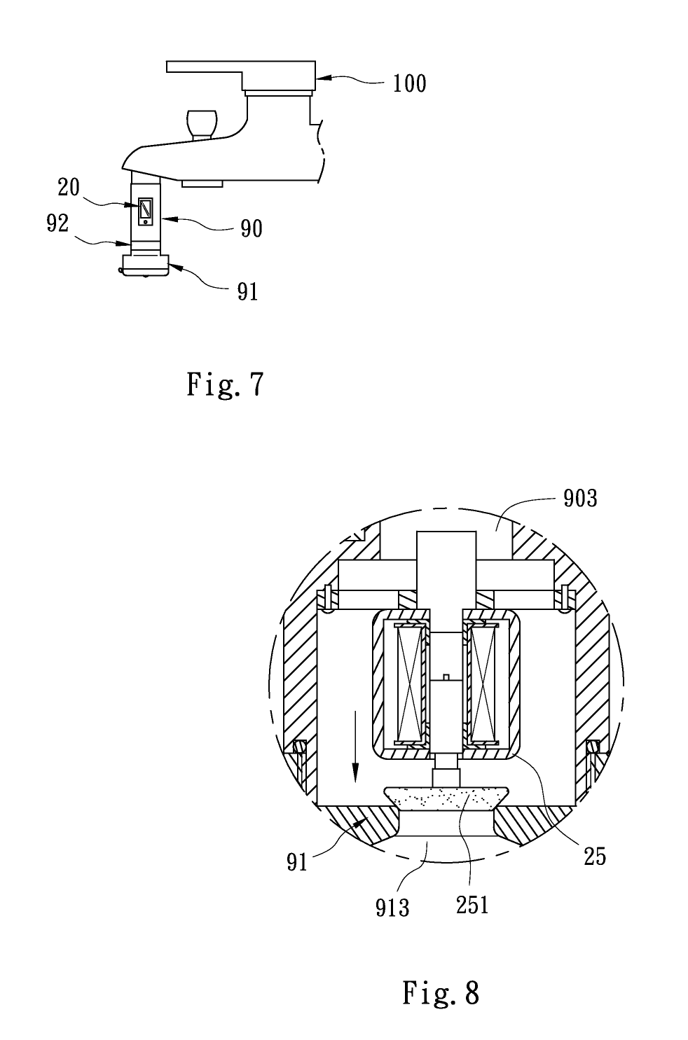

Aside from being installed in the shower head body 60 (see FIG. 4) and being connected between the shower head body 200 and the hose 300 (see FIG. 1), the water filter and alert assembly of the present invention can be connected to the faucet body 100 alone and serve as a water outlet. This is illustrated in FIGS. 6 and 7 as a fourth embodiment of the present invention.

In this embodiment, the water filter and alert assembly includes a housing 90, a cap 91, an alert device 20, and an outgoing water regulating unit 92.

The housing 90 has an externally threaded end 901, an internally threaded end 902, and a water passageway 903.

The cap 91 has an externally threaded end 911 and an internally threaded end 912. The internally threaded end 912 is connected with the externally threaded end 901 of the housing 90, and the externally threaded end 911 is configured to guide outgoing water.

The alert device 20 includes a temperature indicating element 21, a temperature sensing element 22, a display panel 23, a battery 24, and a safety valve 25.

The safety valve 25 is provided in the water passageway 903. When water temperature reaches a predetermined high temperature value, the valve stem 251 of the safety valve 25 blocks the water passageway 903 and thereby stops the water flow immediately. Thus, the safety valve 25 prevents the outflow of water having an overly high temperature and provides enhanced safety.

The outgoing water regulating unit 92 includes a casing 921 having a hollow chamber 922 and an internally threaded end 923, a water outlet plate 925 formed with plural holes 924, a first water distribution plate 926, a second water distribution plate 927, an adjustment lever 928, and a filter element 929. The first water distribution plate 926 has more holes than the second water distribution plate 927. The second water distribution plate 927 can be moved by operating the adjustment lever 928 so as to change the relative positions between the holes of the two water distribution plates 926 and 927 and thereby control different water outflow modes.

In this embodiment, the water filter and alert assembly further includes a plurality of water permeable elements 40 and a plurality of sealing rings 50. The sealing rings 50 are provided respectively at the joints between the housing 90, the cap 91, the casing 921, and the water outlet plate 925. The two water permeable elements 40 are placed in the hollow chamber 922 of the casing 921 in such a way that the filter element 929 is sandwiched vertically between the water permeable elements 40.

The fourth embodiment has the same water filtering and water temperature monitoring functions as the previous embodiments but is different from the previous embodiments in that, as shown in FIG. 8, the water passageway 903 is provided therein with the safety valve 25. Once the temperature sensing element 22 senses that the temperature of the water supplied from the faucet body 100 has reached the predetermined high temperature, the valve stem 251 of the safety valve 25 is pushed outward against the rim of a through hole 913 in the cap 91. Thus, the water is stopped from flowing out, and burns which may otherwise result from the high-temperature water are prevented.

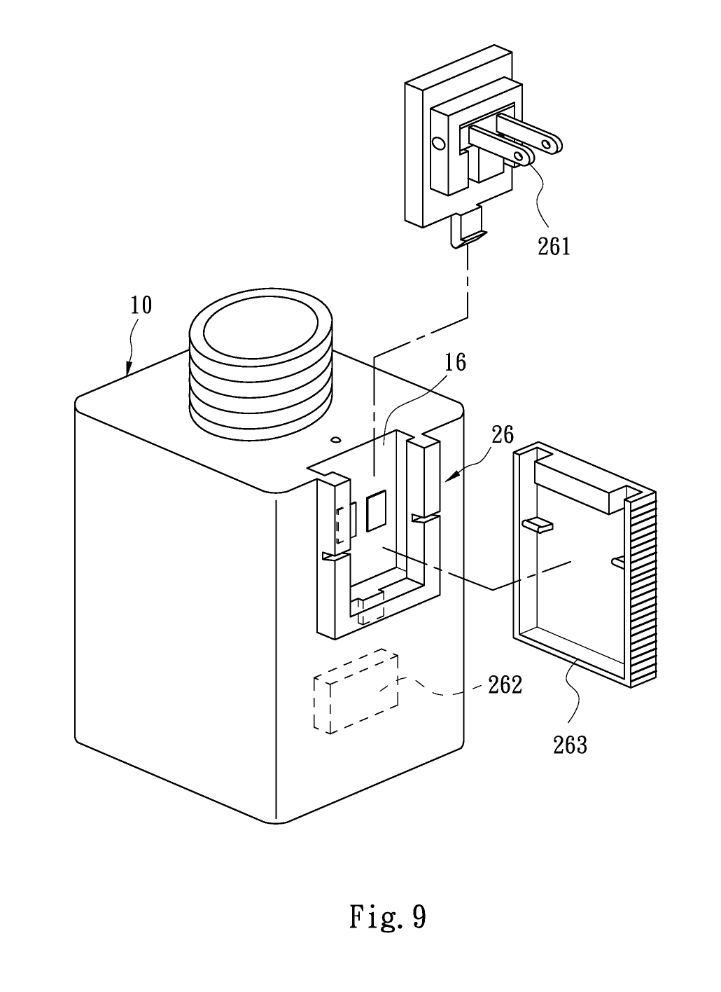

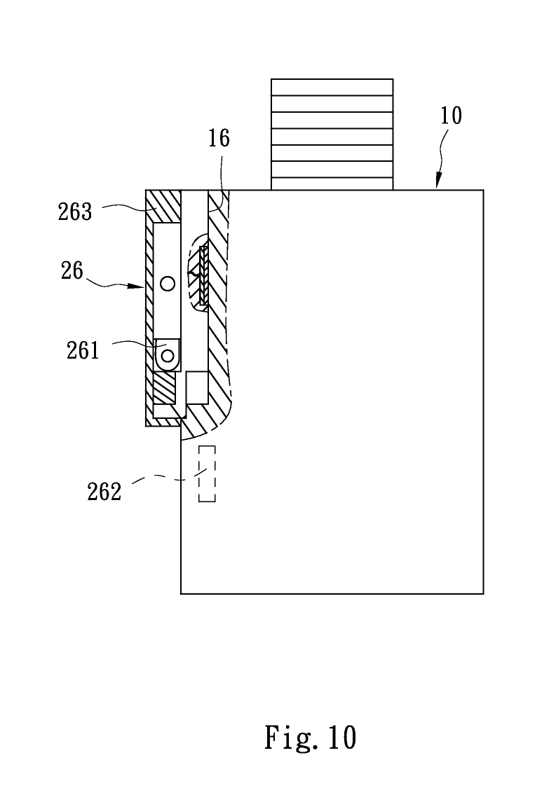

Referring to FIG. 9, the water filter and alert assembly according to a fifth embodiment of the present invention further includes a power supply unit 26. The power supply unit 26 includes a power plug 261 and a rechargeable battery 262. The housing 10 of the assembly has a lateral side formed with a plug connecting groove 16 to which the power plug 261 is connected in a detachable manner. Through the power plug 261, external power not only can be supplied to the alert device but also can be stored in the rechargeable battery 262 for later use. As shown in FIG. 10, when the power plug 261 is not in use, the metal pins of the power plug 261 can be folded downward to facilitate storage. Additionally, an outer cover 263 can cover the plug connecting groove 16 and the power plug 261 from outside for waterproof purposes. The type of the power plug 261 can be changed to suit the socket specifications of different countries.

In summary, the water filter and alert assembly of the present invention has the following advantageous effects:

1. The at least one filter element provides a filtering function whereby the chlorine content of tap water can be reduced, and the impurities and bacteria in tap water filtered out. Hence, the chances of infection and other hazards which may otherwise result from the residual chlorine and bacteria in tap water are minimized.

2. With the alert device monitoring the temperature of outgoing water, the user can be aware of the water temperature all the time while taking a bath or shower. When the water temperature is higher than a predetermined high temperature, the temperature indicating element can emit red light as a warning, and the display panel can display the current water temperature at the same time to avoid burning.

3. The water filter and alert assembly not only can be connected to a faucet body, but also can be connected between a hose and a shower head body, or connected to the shower head body to form a single unit therewith. In other words, the water filter and alert assembly can be located near the faucet body or the shower head body as needed. Further, the water filter and alert assembly features easy installation and removal and can be carried around conveniently during travel.

4. The safety valve can stop hot water from flowing out and thereby protect the user from being burned.

What is claimed is:

1. A water filter and alert assembly for bathroom use, comprising:
a housing having an externally threaded end, an internally threaded end, and a water passageway;
at least a filter element provided in the water passageway;
an alert device provided on the housing and comprising a temperature sensing element and a temperature indicating element, wherein the temperature sensing element is disposed in the water passageway so as to sense a temperature of water passing through the water passageway, and the temperature indicating element is configured to show different alert messages according to the temperature of the water; and
a cap having an externally threaded end and an internally threaded end, wherein the internally threaded end of the cap is connected with the externally threaded end of the housing so as to guide the water out and retain the at least a filter element.

2. The water filter and alert assembly of claim 1, wherein the at least a filter element comprises one of a filter sponge, a photocatalyst, activated carbon, a perfume essence, porphyritic andesite, and zeolite.

3. The water filter and alert assembly of claim 1, further comprising a plurality of water permeable elements and a sealing ring, wherein the sealing ring and one said water permeable element are provided on a central step portion of the housing, and another said water permeable element is provided on a bottom wall of an inner chamber of the housing, the water permeable elements being configured to retain the at least a filter element and allow passage of the water.

4. The water filter and alert assembly of claim 1, further comprising a power generation unit, wherein the housing is provided on a shower head body, and the power generation unit is provided at a water outlet end of the shower head body and is driven by water pressure in the shower head body to generate power to be supplied to the alert device.

5. The water filter and alert assembly of claim 1, further comprising a safety valve provided in the water passageway, wherein when the temperature of the water reaches a predetermined high temperature value, a valve stem of the safety valve blocks the water passageway and thereby stops the water from flowing out.

6. The water filter and alert assembly of claim 1, further comprising an outgoing water regulating unit, the outgoing water regulating unit comprising: a casing having a hollow chamber and an internally threaded end, wherein the hollow chamber receives the at least a filter element, and the internally threaded end of the casing is connected with the externally threaded end of the housing; a water outlet plate formed with a plurality of holes; a first water distribution plate; a second water distribution plate; and an adjustment lever operable to change relative positions between holes of the first water distribution plate and holes of the second water distribution plate and thereby control different water outflow modes.

7. The water filter and alert assembly of claim 1, further comprising a power supply unit provided on the housing, the power supply unit comprising a power plug and a rechargeable battery, wherein the power plug is detachably provided on a lateral side of the housing and is configured to connect external power to the alert device.
